(19) United States
(12) Patent Application Publication
(10) Pub. No.: US 2006/0088315 A1
(43) Pub. Date: Apr. 27, 2006

(54) Camera housing and method of forming camera housing

(76) Inventors: Basavaraj Rajashekhar Kappali, Singapore (SG); Eduardo Martres, Fort Collins, CO (US); Michael L. Manda, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/970,496

(22) Filed: Oct. 21, 2004

(51) Int. Cl. G03B 17/02

(52) U.S. Cl. 396/535

(57) ABSTRACT

A camera housing that includes a substantially planar front surface having a top edge and a bottom edge. The front surface includes an arcuate recess for accommodating a portion of a user's finger during photography, the arcuate recess extending from a location to the bottom edge and having a depth and width that increases from a first depth and first width at the location to a deeper second depth and wider second width adjacent the bottom edge.

### BACKGROUND

Small hand-held cameras can be provided with finger-gripping surfaces on the front face of the camera housing to assist in positioning the user's fingers. Specifically, the right hand of the user is generally used as the main gripping hand. The index finger thereof is used to press a shutter release button, and the other fingers are used to grip the camera housing.

Often the contours of the gripping surfaces are so dimensioned in their design that they are not able to readily accommodate fingers and palms of different sizes. The user of such cameras can potentially grip the camera in a position where the user would be blocking a portion of the lens or the flash window, in cameras with built-in flash units. Additionally, such gripping surface may require that the user position both hands on the camera to further steady the camera while taking photos. This can make taking photos more tedious and time consuming.

### SUMMARY

One embodiment of the present invention may comprise a camera housing that includes a substantially planar front surface having a top edge and a bottom edge. The front surface includes an arcuate recess for accommodating a portion of a user's finger during photography, the arcuate recess extending from a location to the bottom edge and having a depth and width that increases from a first depth and first width at the location to a deeper second depth and wider second width at the bottom edge.

Another embodiment may comprise a camera that includes a substantially planar front surface, a substantially parallel rear surface, and a bottom surface joining the front surface and the rear surface. The front surface includes a lens aperture and a finger grip portion. The finger grip includes a first recessed surface inwardly offset into the front surface, the recessed surface having an arcuate profile and extending from a location on the front surface to the bottom surface.

Yet another embodiment may comprise a camera that includes means for housing at least one of electrical and mechanical components of the camera, the means for housing having a substantially planar front surface. The camera also may include means for gripping the front surface with a user's middle finger, the means for gripping including an arcuate recessed surface inwardly offset into the front surface. The recessed surface extends from a first location on the front surface to a second location adjacent a bottom edge of the front surface.

Still another embodiment may comprise a method of forming a front surface of a camera housing. The method may include providing a substantially flat stainless steel sheet. The stainless steel sheet is substantially rectangular in shape and including a first edge and a substantially parallel second edge spaced apart from the first edge. The method may also include forming an arcuate recess in the stainless steel sheet, the recess extending from a location on a surface of the stainless sheet between the first edge and second edge to the first edge. The recess has a depth and width that increase from a first depth and first width at the location to a deeper second depth and wider second width at the first edge.

### BRIEF DESCRIPTION OF THE DRAWINGS

FIG. 1 illustrates a schematic perspective view of one embodiment of a camera.

FIG. 2 illustrates a schematic front view of the embodiment of the camera.

FIG. 3 illustrates a schematic rear view of the embodiment of the camera.

FIG. 4 illustrates a schematic perspective view of the embodiment of the camera being grasped by a hand.

FIG. 5 illustrates a schematic bottom view of the embodiment of the camera being grasped by the hand.

FIG. 6 illustrates a schematic block diagram of a method of forming a portion of an embodiment of a camera.

FIG. 7 illustrates a schematic block diagram of another method of forming the portion of the embodiment of the camera.

### DETAILED DESCRIPTION

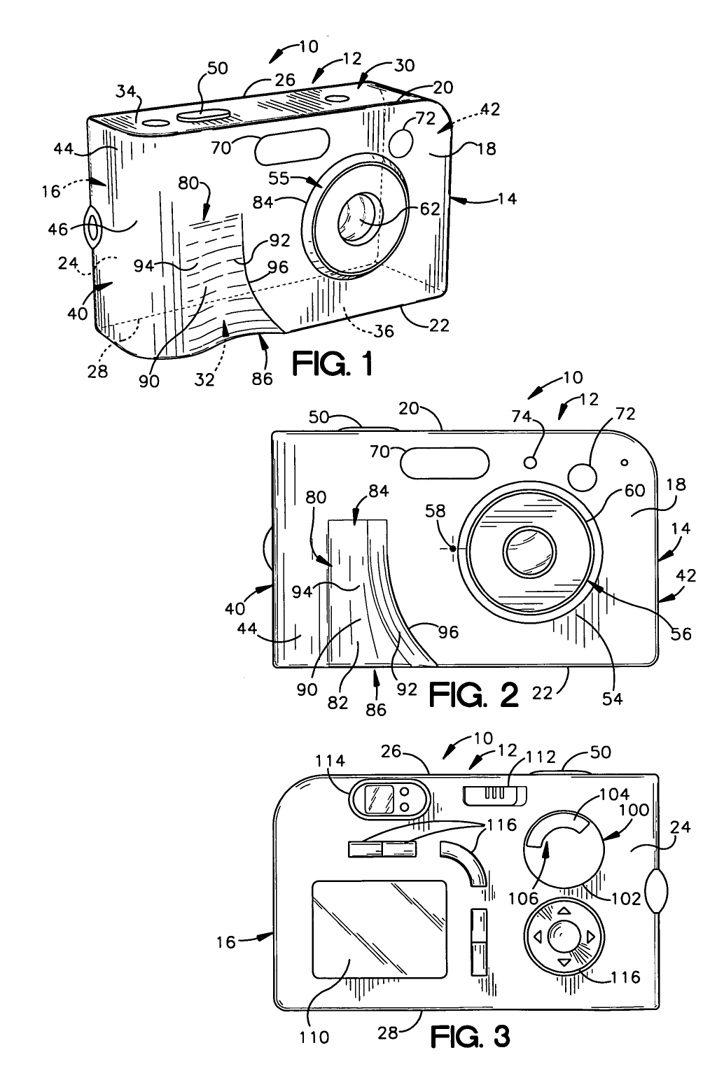

FIG. 1 illustrates a schematic perspective view of an exemplary hand-held camera 10. The hand-held camera 10 illustrated in this view can be a digital camera that takes discrete still digital images or moving images (e.g., videos) and compresses and stores the digital data files representative of the digital images in a memory device, such as a SRAM, RAM, hard disk, tape, or flash memory. Alternatively, the hand-held camera 10 can be a film-based camera that takes still images and records them on film.

The camera 10 is provided with a substantially rectangular shaped camera housing 12 that includes a substantially rectangular front portion 14 and a substantially rectangular rear portion 16 (FIG. 3). The housing 12 provide means for housing one or more of electrical and mechanical components of the camera 10, which components can vary according to the type and configuration of camera. Referring to FIG. 2, which illustrates a schematic front view of the camera 10, the front portion 14 defines a substantially planar front surface 18 that extends between a top edge 20 and a bottom edge 22. By “substantially planar” as used in the specification and claims, it is meant that the surface is generally flat but can include some deviations from the surface. Referring now to FIG. 3, which illustrates a schematic rear portion of the camera 10, the rear portion 16 defines a rear surface 24 with a top edge 26 and a bottom edge 28 that is substantially parallel with the front surface 18 (FIG. 2). Although the rear surface 24 like the front surface 18 is illustrated as being substantially planar, the rear surface 24 need not be substantially planar and can include substantial deviations (e.g., projections) from the rear surface 24.

Referring to FIG. 1, the front surface 18 and the rear surface 24 of the camera housing 12 are joined at the top edges 20 and 26 and the bottom edges 22 and 28 by top and bottom portions 30 and 32 of the housing 12, respectively. The top portion 30 and bottom portion 32 define, respectively, substantially planar top and substantially planar bottom surfaces 34 and 36 that are substantially parallel to one another. The front surface 18 and the rear surface 24 are also joined and at their respective sides by right-hand and left-hand portions 40 and 42 of the housing 12. Hereafter the term “right-hand” and “left-hand” will refer to those portions of the camera 10 associated with the user's right and left hands respectively. Thus, for example, the right-hand portion 40 is on the left side of the camera 10 as seen in the front schematic view of FIG. 2. This terminology will be employed consistently throughout.

The right-hand portion 40 and the front surface 16 of the front portion 14 form a palm grip portion 44 of the camera housing 12. The palm grip portion 44 of the camera housing 12 can be gripped by a user's palm when the camera 10 is held in the user's hand for photography. The palm grip portion 44 has a generally curved surface 46 that extends from the top edge 20 to the bottom edge 22. The curvature of curved surface 46 of the palm grip portion 44 is such that the palm grip portion 44 readily conforms to the user's palm during gripping and allows the user to more readily grip the camera 10 during photography. It will be appreciated the curved surface 46 of the palm grip portion 44 can have other shapes or profiles (e.g., rectangular) and that these other shapes of profiles can increase or decrease the user's ease of gripping the camera 10. Along the top portion 30 of the camera housing 12 is disposed a shutter release button 50. The shutter release button 50 is disposed on the top surface 34 near the right-hand side of the camera housing 12. The shutter release button 50 is configured in the form of a generally rectangular button that can be readily actuated by the index finger of the user during photography. The shutter release button 50 may also be configured in various other shapes such as circular or oval.

Referring again to FIG. 2, the front portion 14 of the camera housing 12 includes a lens assembly aperture 54 (i.e., lens aperture) through which a lens assembly 56 can at least partially extend. The lens aperture 54 is substantially centered on the front surface 18 of the camera housing 12 so that the lens aperture 54 is substantially midway between the top edge 20 and the bottom edge 22 of the front surface 18 and offset to the left-hand side of a center point 58 between the sides portions 40 and 42 of the camera housing 12. It will be appreciated, however, that the lens aperture 54 and lens assembly 56 need not be substantially centered but may be located at other positions on the front surface 18 of the camera housing 12.

The lens aperture 54 has a substantially cylindrical shape to accommodate the substantially cylindrical shape of the lens assembly 56. The lens aperture, however, can have other shapes, and these other shapes can be dependent on the shape of the lens assembly 56.

The lens assembly 56 can include a lens barrel 60 for holding an optical taking lens 62. The lens 62 can be similar to other lenses and flashes found on other digital cameras or film-based cameras. The lens barrel 60 can be adapted to telescope or project from the lens aperture 54 so that the focal length of the camera 10 can be readily adjusted.

The front portion 14 of the camera housing 12 also includes a flash device 70, a front view finder objective window 72, and a light adjusting sensor 74 all disposed above the lens aperture 54 on the front surface 18 of the camera housing 12. It will be appreciated that the flash device 70, the front view finder objective window 72, and the light adjusting sensor 74 can be provided at other locations along the front surface 18. Moreover, it will be appreciated that the camera housing 12 need not include the flash device 70, the view finder objective window 72, and light adjusting sensor 74.

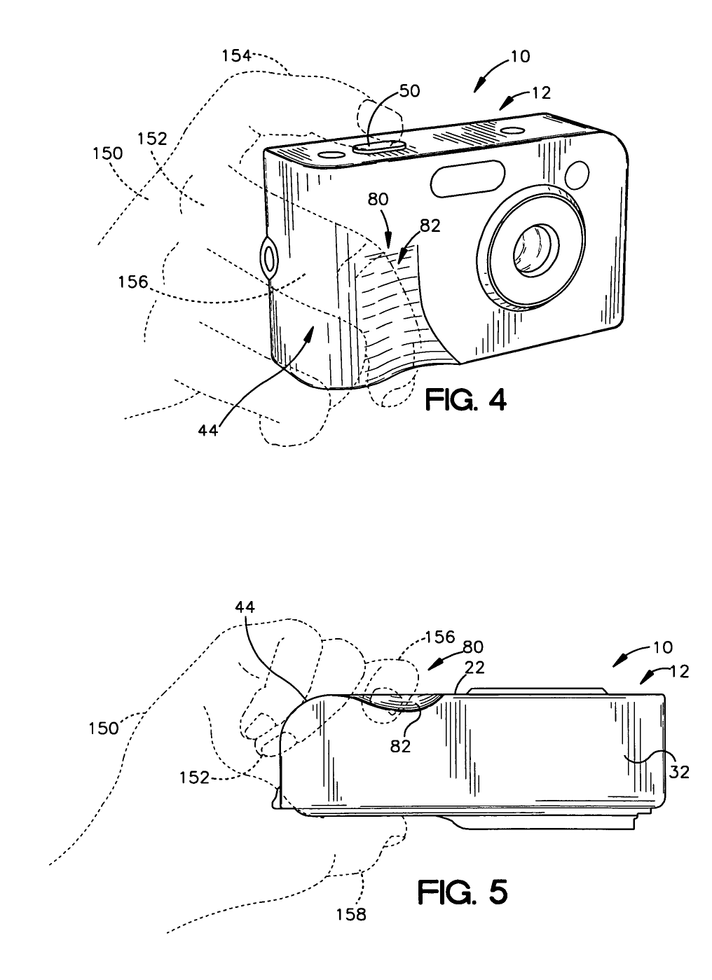

The front surface 18 of the front portion 14 of the camera housing 12 also includes a finger grip portion 80 for gripping and steadying the camera 10 during photography. The finger grip portion 80 is provided substantially below the shutter release button 50 so that the finger grip portion 80 can be gripped by the user's middle finger while the shutter release button 50 is actuated by the user's index finger (FIG. 4). The finger grip portion 80 includes an inwardly offset or rearwardly offset recess 82 that extends from a midway point 84 on the front surface 18 to the bottom edge 22. The midway point 84 is substantially midway from the top edge 20 and bottom edge 22. The midway point 84 is also laterally spaced on the front surface 18 between the lens aperture 54 and palm grip portion 44 of the camera housing 18 so that when the user's finger (e.g., middle finger) is accommodated in the recess 82 the user's finger (as well as other fingers) do not obstruct the optical lens 62 as well as the flash device 70, the view finder objective window 72, and the light adjusting sensor 74, if provided on camera 10. Additionally, the extension of the recess 82 to the bottom edge 22 of the front surface 18 provides the recess 82 with an open end 86. This open end 86 of the recess 82 allows the user's finger (e.g., middle finger) accommodated in the recess 82 to extend beyond the camera housing 12 and readily grip the bottom portion 32 of the camera 10 so that camera 10 is further stabilized during photography.

The recess 82 has a first depth and a first width at the midway point 84 and a deeper second depth and wider second width at the bottom edge 22. The increase in depth and width of the recess 82 is gradual so as to provide the recess 82 with an arcuate smooth recessed surface 90. This smooth recessed surface 90 allows the user's finger during photography to be readily accommodated in the recess 82 and provides the user with a very firm and comfortable surface to grip.

The recessed surface 90 includes a beveled surface 92 and a transition surface 94. The beveled surface 92 has a substantially arcuate or curved shape that is concave to the lens aperture 54 (i.e., concave portion of the beveled surface 92 faces the lens aperture 54). The beveled surface 92 extends inwardly or rearwardly from the front surface 18 between the midway point 84 and the bottom edge 22. The beveled surface defines arcuate edge 96 with the front surface 18. The arcuate edge 96 forms a readily felt sharply angled boundary that serves as a reference for positioning the user's finger in the recess 82 (i.e., a reference between the recess 82 and lens aperture 54). Further, the angle of the arcuate edge 96 with respect to the palm grip portion 44 and the bottom edge 22 is such that the user's finger (e.g., middle finger) can be readily accommodated in the recess 82 when gripping the camera housing 12.

The transition surface 94 like the beveled surface 92 has a substantially arcuate shape that is concave to the lens aperture 54. The transition surface 94 extends from the beveled surface 92 between the midway point 84 and the bottom edge 22. The width of the transition surface 94 increases from a first width at the midway point 84 to a second width at the bottom edge 22. The transition surface 94 gradually merges with the palm grip portion 44 so as to form a substantially continuous smooth surface. This smooth surface allows the user of the camera during photography to move or reposition a finger (e.g., middle finger) accommodated in the recess 82 with minimal strain and difficulty.

Referring again to FIG. 3, the rear surface 24 includes a second grip portion 100 for gripping the rear surface 24 of the camera housing 12. The second grip portion 100 includes a circular recess 102 with a truncated hemispherical profile that can readily accommodate the user's thumb to prevent slipping of the camera 10 when the camera 10 is held in the user's hand for photography. The circular recess 102 is aligned on the rear surface 24 substantially below the shutter release button 50 to allow the circular recess 102 to be gripped by the user's thumb when the user's index finger actuates the shutter release button 50.

A zoom control button 104 is provided along an upper surface 106 of the circular recess 102 to adjust the focal depth of the lens 62 (FIG. 2). When the zoom control button 104 is pressed the lens barrel 60 can extend or detract to control the focal depth. This conveniently allows the user to adjust the focal length of the camera 10 with out repositioning the user's fingers during photography.

It will be appreciated by one skilled in the art that the second finger grip portion 100 (i.e., thumb grip portion) need not be provided in the form of a circular recess 102 to grip the rear surface 24 of the camera housing 12. It is possible to use other shaped recesses, projections, grooves, ridges, and the like besides or in addition to the circular recess 102. Additionally, it will be appreciated that the camera 10 need not be provided with a second grip portion 100 or with a zoom control button 104, which is provided as part of the second finger grip portion 102. The user's thumb can grasp the rear surface 24 to grip and stabilize the camera 10 and adjust, if applicable, the focal length of the lens 62 by other means.

The rear portion 16 of the camera 10 also includes a display 110 (e.g, liquid crystal display (LCD)) as well as a power switch 112, a rear view finder objective window 114, and function control buttons 116, such as a scrolling button, a select button, a delay timer button, an exposure offset button, a display previous picture(s) button, a display next picture(s) button, a delete last picture button, and a delete all pictures button. The display 110, power switch 112, rear view finder objective window 114, and function control buttons 116 can be provided along the rear surface to the left (e.g., display 110, power switch 112, and rear view finder objection window 114, and function control buttons 116) or below (e.g., other control buttons 116) the second finger grip portion 116. It will be appreciated, however, that the display 110, power switch 112, rear view finder objective window 114 and function control buttons 116 can be provided at other locations along the rear surface 24. Moreover, it will be appreciated that the camera housing 12 need not include the display 110, power switch 112, rear view finder objective window 114 and other control buttons 116.

FIGS. 4 and 5 are schematic views illustrating an example of a way in which the camera 10 can be grasped by a user's hand 150 during photography. Referring to FIG. 4, the palm grip portion 44 of the camera 10 may rest against a palm 152 of the user's right hand 150 while an index finger 154 of the right hand 150 of the user may be comfortably placed on the shutter release button 50 and a middle finger 156 of the right hand 150 may be comfortably curled to lie against the finger grip portion 80. The arcuate recess 82 of the finger grip portion 80 is configured to comfortably accept the middle finger 156 and to prevent it from accidentally covering, for example, the lens 62. Referring to FIG. 5, because the recess 82 extends to the bottom edge 22 of the camera 10, the user's middle finger 156, if long enough, when lying in the recess 82 can readily grip the camera housing 12 along its bottom portion 32 to further steady the camera during photography. Moreover, users with shorter middle fingers 156 can get a firm grip on the recessed surface 82. Additionally, the thumb 158 of the user's right hand 150 can be comfortably placed against the second finger grip portion 100 to further steady the camera 10.

Referring to FIG. 1, the front portion 14 and rear portion 16 of the camera housing 12 can be formed from any material, such as a plastic, metal, ceramic, or combination thereof. In one example, the front portion 14 of the camera housing 12 is formed from stainless steel. Stainless steel provides the front portion 14 of the camera housing 12 with a smooth front surface 18 that is wear resistant, sturdy feeling, and visually appealing.

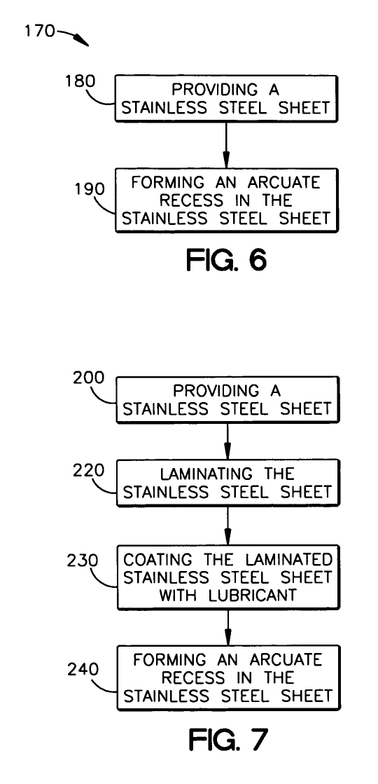

FIG. 6 depicts an example of a method 170 of forming a front surface of a camera housing. The method may comprise providing a substantially flat stainless steel sheet, as shown at 180. The stainless steel sheet can be substantially rectangular in shape and include a first edge and a substantially parallel second edge spaced apart from the first edge. At 190, an arcuate recess is formed in the stainless steel sheet, the recess extending from a location on a surface of the stainless sheet between the first edge and second edge to the first edge, the recess having a depth and width that increase from a first depth and first width at the location to a deeper second depth and wider second width at the first edge.

FIG. 7 is a schematic block diagram illustrating an exemplary method of forming a stainless steel front portion of a camera housing that has finger grip portion similar to the camera housing 12 of FIGS. 1-5. In the method, at 200, a brushed, stainless sheet is provided. The brushed stainless sheet can have a flat substantially rectangular shape with a first longitudinal edge and a substantially parallel second longitudinal edge. The first longitudinal edge and the second longitudinal edge can be joined by substantially perpendicular and spaced apart first and second lateral edges. The stainless steel sheet can have an area slightly greater (e.g., about 1% to 10% greater) than the area of the front surface of the camera housing. The thickness of the stainless steel sheet can be that thickness, which is effective to allow the stainless steel sheet to be readily formed into the profile of the front surface of the camera housing. Accordingly, the stainless steel sheet should not be too thin so as to be readily damaged when processed, and or too thick, to prevent processing into the desired shape. One exemplary thickness is from about 0.3 mm to about 0.5 mm (e.g., 0.4 mm).

The stainless steel sheet can be formed from any stainless steel that can be provided in sheet form and readily processed into the profile of the front surface of the camera housing. One example of a grade of stainless steel that can be used is SUS 304 low-carbon stainless steel. It will be appreciated that other 3XX steel grades as well as other stainless steel grades can also be used.

The stainless steel sheet can have hairline surface finish on one surface (i.e., front face) of the stainless steel sheet. The hairline surface finish can be provided by mechanically brushing or polishing the stainless steel sheet.

At 240, an arcuate recess is formed in the stainless steel sheet that is rearwardly offset from the front face of stainless steel sheet. The arcuate recess can extend from a midway point on the front face to the first longitudinal edge of the steel sheet. The midway point is substantially midway from the top edge and bottom edge. The midway point is also laterally spaced between the first and second lateral edges. The arcuate recess can have a first depth and first width at the midway point on the steel sheet and a deeper second depth and wider second width at the first longitudinal edge. The increase in depth and width of the recess is gradual so to provide the recess with an arcuate smooth surface.

The recess includes a recessed surface with a beveled surface and a transition surface. The beveled surface has a substantially arcuate or curved shape that is concave to a central portion of the stainless steel sheet. The beveled surface extends inwardly or rearwardly from the front face of the steel sheet. The beveled surface defines arcuate edge with on the stainless steel sheet. The transition surface like the beveled surface has a substantially arcuate shape that is concave to the center portion of the stainless steel sheet. The transition surface extends from the beveled surface between the midway point and the first longitudinal edge. The width of the transition surface increases from a first width at the midway point to a second width at the bottom edge. The transition surface gradually merges with the front face surface so as to form a substantially continuous smooth surface.

The arcuate recess can be formed in the stainless steel sheet by punch and die sheet metal tool techniques. In such techniques, the stainless steel sheet can be provided in a die that includes a female portion with a recess similar in shape to the arcuate recess and stamped with a punch that has a male portion with a protrusion similar in shape to the arcuate recess.

Following formation of the recess, the edges of the stainless steel sheet can be trimmed and various holes or apertures can be formed in the stainless steel sheet by piercing and coining methods for the lens assembly, flash device, the view finder objective window, and the light adjusting sensor aperture.

Optionally, as illustrated in FIG. 7, after providing the stainless steel sheet 200 and prior to formation of the arcuate recess 240, the method, at 220, can include laminating the front face of the stainless steel sheet with a plastic layer. The plastic layer mitigates damage (e.g., dents and scratches) that can occur to the hairline finish during formation of the arcuate recess and formation of the holes or apertures. The plastic layer can also reduce the gap between the punch and the die when the arcuate recess is formed in the stainless steel sheet. This gap reduction is advantageous as it allows for more accurate dimensioning of the arcuate recess during formation.

Following lamination of the front face of the stainless steel sheet at 220 and prior to formation of the arcuate recess at 240, the laminated stainless steel surface at 230 can be coated with a lubricant. The lubricant can mitigate adverse deformation, such as tearing of the steel sheet, during formation of the arcuate recess. The lubricant can include any lubricant that acts as a cushion and transfers the load from the punch or die uniformly along the surface of the stainless sheet during formation of the arcuate recess. One example, of a lubricant that can-be used is a MOLYCHEM A-MAX 729 lubricant. MOLYCHEM A-MAX comprises 1% by weight of an anti-rust additive, 5% by weight of butyl alcohol, 0.5% by weight 1,2,3-benzotriazole, and the remainder mineral oil. It will be appreciated that other lubricants can also be used.

Those skilled in the art will understand and appreciate that variations in the camera 10 and the methods of forming portions of the camera 10 can be utilized. For example, it is to be appreciated that although the camera housing 10 is illustrated and described for right-hand use, the camera 10 can be constructed for left-hand use. Moreover, those skilled in the art will understand and appreciate that the front surface 18 and rear surface 24 of the camera housing 12 can include other grip portions.

What has been described above includes examples depicting how the present invention might be implemented. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A camera housing comprising:
a substantially planar front surface having a top edge and a bottom edge, the front surface including an arcuate recess for accommodating a portion of a user's finger during photography, the arcuate recess extending from a location to the bottom edge and having a depth and width that increases from a first depth and first width at the location to a deeper second depth and wider second width at the bottom edge.

2. The camera housing of claim 1, wherein the front surface further comprising a palm grip portion and a laterally spaced lens aperture, the arcuate recess being spaced on the front surface between the palm grip portion and lens aperture.

3. The camera housing of claim 1, wherein the arcuate recess further comprising a beveled surface, the beveled surface extending from front surface and defining an arcuate edge, the arcuate edge extending from the location to the bottom edge to provide a reference on the front surface for the user's finger.

4. The camera housing of claim 3, wherein the arcuate edge is substantially concave to the lens aperture.

5. The camera housing of claim 3, wherein the arcuate recess further comprises an arcuate transition surface that extends from the beveled surface, the arcuate transition surface gradually merging with the palm grip portion of the front surface so as to form a substantially continuous smooth surface.

6. The camera housing of claim 2, further comprising a top surface that extends from a top edge of the front surface, the top surface including a shutter release button substantially aligned over the arcuate recess.

7. The camera housing of claim 6, wherein the arcuate recess is laterally spaced from the palm grip portion such that when the cameral housing is held in the user's hand, a middle finger of the user's hand can be readily positioned in the recess while the an index finger of the user's hand is placed in contact with the shutter release button.

8. The camera housing of claim 7, further comprising a rear surface spaced apart and generally opposing the front surface, the rear surface including a second recess for accommodating a portion of the user's thumb during photography.

9. The camera housing of claim 8, wherein the second recess is located on the rear surface aligned substantially below the shutter release button.

10. The camera housing of claim 1 further comprising a stamped metal sheet, the stamped metal sheet defining at least the front surface of the camera housing.

11. The camera housing of claim 1, wherein the stamped metal sheet comprises stainless steel.

12. A camera comprising:
a substantially planar front surface;
a substantially parallel rear surface; and
a bottom surface joining the front surface and the rear surface, the front surface including a lens aperture and a finger grip portion, the finger grip including a first recessed surface inwardly offset into the front surface, the recessed surface having an arcuate profile and extending from a location on the front surface to the bottom surface.

13. The camera of claim 12, wherein the recessed surface further comprises a beveled surface, the beveled surface extending from the front surface toward the rear surface and defining an arcuate edge, the arcuate edge providing a reference that extends arcuately between the recess and the lens aperture for the photographer's finger.

14. The camera of claim 12, wherein the finger grip portion has a depth and width that increase from a first depth and first width at the location to a deeper second depth and wider second width adjacent the bottom surface.

15. The camera of claim 13, further comprising a palm grip portion laterally spaced on the front surface from the lens aperture, the finger grip portion being spaced on the front surface between the palm grip portion and lens aperture.

16. The camera of claim 13, wherein the arcuate edge is substantially concave to the lens aperture.

17. The camera of claim 13, wherein the recessed surface further comprises an arcuate transition surface that extends from the beveled surface, the arcuate transition surface gradually merging with the palm grip portion of the front surface so as to form a substantially continuous smooth surface.

18. The camera of claim 13, further comprising a top surface, the top surface being substantially parallel to the bottom surface and joining the front surface and rear surface, the top surface including a shutter release button, the shutter release button being substantially aligned over the finger grip portion.

19. The camera of claim 18, wherein the finger grip portion is laterally spaced from the palm grip portion such that when the camera is held in a user's hand, a middle finger of the user's hand can be readily accommodated in the recess while an index finger of the user's hand is placed in contact with the shutter release button.

20. The camera of claim 12, wherein the rear surface further comprises a second finger grip portion for accommodating a portion of the user's thumb during photography.

21. The camera of claim 20, wherein the second finger grip portion comprises a second recess that is located on the rear surface aligned substantially below the shutter release button.

22. The camera of claim 12, further comprising a stamped stainless steel sheet, the stamped steel sheet defining the front surface of the camera housing.

23. A camera comprising:
means for housing at least one of electrical and mechanical components of the camera, the means for housing having a substantially planar front surface; and
means for gripping the front surface with a user's middle finger, the means for gripping including an arcuate recessed surface inwardly offset into the front surface, the recessed surface extending from a first location on the front surface to a second location adjacent a bottom edge of the front surface.

24. The camera of claim 23, wherein the recessed surface further comprises a beveled surface, the beveled surface extending rearwardly from the front surface to define means for providing an arcuately extending edge reference between the recess and the lens aperture for the photographer's finger.

25. The camera of claim 24, wherein the recessed surface has a depth and width that gradually increases from a first depth and first width at the point to a deeper second depth and wider second width at the bottom.

26. A method of forming a front surface of a camera housing, the method comprising:
providing a substantially flat stainless steel sheet, the stainless steel sheet being substantially rectangular in shape and including a first edge and a substantially parallel second edge spaced apart from the first edge; and
forming an arcuate recess in the stainless steel sheet, the recess extending from a location on a surface of the stainless sheet between the first edge and second edge to the first edge, the recess having a depth and width that increase from a first depth and first width at the location to a deeper second depth and wider second width at the first edge.

27. The method of claim 26, further comprising laminating a surface of the stainless sheet prior to forming the arcuate recess.

28. The method of 27, further comprising coating the laminated surface of stainless sheet with a lubricant prior to forming the arcuate recess.

29. A front surface of a camera housing produced according to the method of claim 26.
